(19) United States
(12) Patent Application Publication
(10) Pub. No.: US 2025/0175853 A1
(43) Pub. Date: May 29, 2025

(54) CROSS LAYER RATE CONTROL FOR WIRELESS COMMUNICATIONS

(71) Applicant: VIREWIRX, Inc., San Diego, CA (US)

(72) Inventors: David Edward Howard, San Diego, CA (US); Ali A. Elghariani, San Diego, CA (US); Siddhartha Mallik, San Diego, CA (US); Jaspreet Singh, San Diego, CA (US)

(21) Appl. No.: 18/919,167

(22) Filed: Oct. 17, 2024

Related U.S. Application Data
(60) Provisional application No. 63/602,970, filed on Nov. 27, 2023.

(51) Int. Cl. H04W 28/02

(52) U.S. Cl. CPC H04W 28/0289; H04W 28/0231

(57) ABSTRACT

Aspects of this disclosure relate to methods of cross layer rate selection and related controllers and systems. A media access control scheduler can select a rate for transmitting data for a wireless terminal based on a queue stability metric and a predicted transmission rate associated with the wireless terminal. Information identifying the rate can be sent to an application server. The rate can then be used by application server to send data for the wireless terminal to an access point via an access point controller, in which the access point can wirelessly serve the wireless terminal.

### CROSS REFERENCE TO PRIORITY APPLICATION

This application claims the benefit of priority of U.S. Provisional Patent Application No. 63/602,970, filed Nov. 27, 2023 and titled “CROSS LAYER RATE CONTROL FOR WIRELESS COMMUNICATIONS,” the disclosure of which is hereby incorporated by reference herein in its entirety and for all purposes.

### BACKGROUND

### Technical Field

Embodiments of this disclosure relate to for wireless communication systems and, more specifically, to rate control for wireless communications.

### Description of Related Technology

The types of modern computing devices continue to increase along with the differing and dynamic needs of each device. The wireless communication systems providing services to such devices are facing increasing constraints on resources and demands for quality and quantities of service. Accordingly, improvements in providing wireless communication services, such as in multi-point wireless environments with high data throughputs, are desired.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a method of cross layer rate selection. The method includes selecting, by a media access control (MAC) scheduler, a rate for transmitting data for a wireless terminal based on (1) a queue stability metric and (2) a predicted transmission rate associated with the wireless terminal; and sending information identifying the rate to an application server.

Another aspect of this disclosure is a controller with cross layer rate selection. The controller includes a one or more interfaces configured to communicate with a network node and to communicate with an application server and a MAC scheduler. The MAC scheduler is configured to select a rate for transmitting data for a wireless terminal based on (1) a queue stability metric and (2) a predicted transmission rate associated with the wireless terminal, cause the controller to send information identifying the rate to the application server, and cause the controller to send data from the application server that is associated with the wireless terminal to the network node at the rate.

Another aspect of this disclosure is a system with cross layer rate selection. The system includes an access point and an access point controller. The access point includes at least one antenna and one or more processors in communication with the at least one antenna. The one or more processors are configured to cause the access point to wirelessly transmit packets to a wireless terminal via the at least one antenna. The access point controller includes a MAC scheduler configured to select a rate for transmitting data for the wireless terminal based on (1) a queue stability metric associated with the wireless terminal and (2) a predicted transmission rate associated with the wireless terminal, cause the access point controller to send information identifying the rate to an application server, and cause the access point controller to send data from the application server to the access point for transmission to the wireless terminal at the rate.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will now be described, by way of non-limiting example, with reference to the accompanying drawings.

FIG. 1 is a schematic diagram of an example wireless communication environment in accordance with embodiments of this disclosure.

FIG. 2 is a block diagram of components of the wireless communication environment of FIG. 1 illustrating operations performed by the components for cross layer rate control according to an embodiment.

FIG. 3 is a flow diagram of operations performed by an access point controller for cross layer rate control according to an embodiment.

FIG. 4 is a flow diagram of operations of an example method of computing a recommended transmission rate according to an embodiment.

FIG. 5 is a schematic diagram of a multipoint environment in which multiple wireless terminals and access points can communicate with each other at rates selected based on one or more methods of this disclosure.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Embodiments of this disclosure relate to cross layer transmission rate control. A user application server can communicate with a media access control (MAC) scheduler for selecting a transmission rate. The user application and the MAC scheduler are in different layers of a network stack. The application server can advertise a set of rates to the MAC scheduler. The application server and the MAC scheduler can communicate with each other over Internet Protocol (IP) in certain applications. The MAC scheduler can select a user rate based on (a) a queue stability metric and (b) a predicted transmission rate for a user device. The MAC scheduler can provide the selected rate to the application server. The application server can use the selected rate to provide data to an access point (AP) via an AP controller to serve the user device.

Aspects of this disclosure relate to methods of cross layer rate selection. A MAC scheduler can select a rate for transmitting data for a wireless terminal based on a queue stability metric and a predicted transmission rate associated with the wireless terminal. Information identifying the rate can be sent to an application server. The application server can send data for the wireless terminal at the rate to an access point via an access point controller.

Then the access point can wirelessly transmit the data to the wireless terminal. Absent congestion, the access point can wirelessly transmit the data to the wireless terminal at a wireless transmission rate that is close to (e.g., within 1% or within 2%) or at the rate. The wireless terminal can be associated with a head mounted display, for example. The method can be performed in a wireless communication environment for virtual reality, for example.

An access point can measure a first number of packets arriving in a data queue for the wireless terminal and a second number of packets wirelessly transmitted from the access point to the wireless terminal. The queue stability metric can be determined based on the first number of packets and the second number of packets. The access point can report the queue stability metric to an access point controller that include the MAC scheduler.

The access point controller can determine the predicted transmission rate from the wireless terminal based on information associated with a wireless channel between the access point and the wireless terminal. The predicted transmission rate can be determined at a different time interval than the queue stability metric.

The MAC scheduler can receive a set of supported transmission rates from the application server, where the rate is included in the set of supported transmission rates. The rate can be reduced based on (a) the queue stability metric being greater than a threshold, where a higher value of the queue stability metric indicates more congestion than a lower value of the queue stability metric; and/or (b) the predicted transmission rate being greater than the rate. The rate can be increased based on the queue stability metric being less than a threshold for a predefined period of time, where a higher value of the queue stability metric indicates more congestion than a lower value of the queue stability metric.

The method can be performed for each wireless terminal being served by an access point that is controlled by the access point controller.

Rate selection methods disclosed herein can be performed continuously, at periodic time intervals, or in response to detecting one or more conditions. In certain applications, rate selection can be performed continuously while an application server is providing data for a user device to dynamically adjust a rate for transmitting data for the user device based on updated information.

Aspects of this disclosure relate to an access point with cross layer rate selection. The access point controller can include one or more interfaces and a MAC scheduler. The one or more interfaces can communicate with an access point and communicate with an application server; and The MAC scheduler can select a rate for transmitting data for a wireless terminal based on (1) a queue stability metric and (2) a predicted transmission rate associated with the wireless terminal; cause the access point controller to send information identifying the rate to the application server; and cause the access point controller to send data from the application server that is associated with the wireless terminal to the access point at the rate.

Another aspect of this disclosure is a system with cross layer rate selection. The system includes the access point of the preceding paragraph and an access point. The access point includes at least one antenna and one or more processors in communication with the at least one antenna. The one or more processors can cause the access point wirelessly transmit packets to the wireless terminal via the at least one antenna.

Embodiments disclosed herein can provide faster and more accurate rate control than certain existing rate control methods. The cross layer transmission rate control disclosed herein can be applied to high throughput wireless communication environments. In certain applications, cross layer transmission rate control can be employed in virtual reality (VR) systems. In such systems, data rate can impact quality of user experience. Issues with data rate in VR systems can detract from user experience, for example, by causing dizziness or nausea.

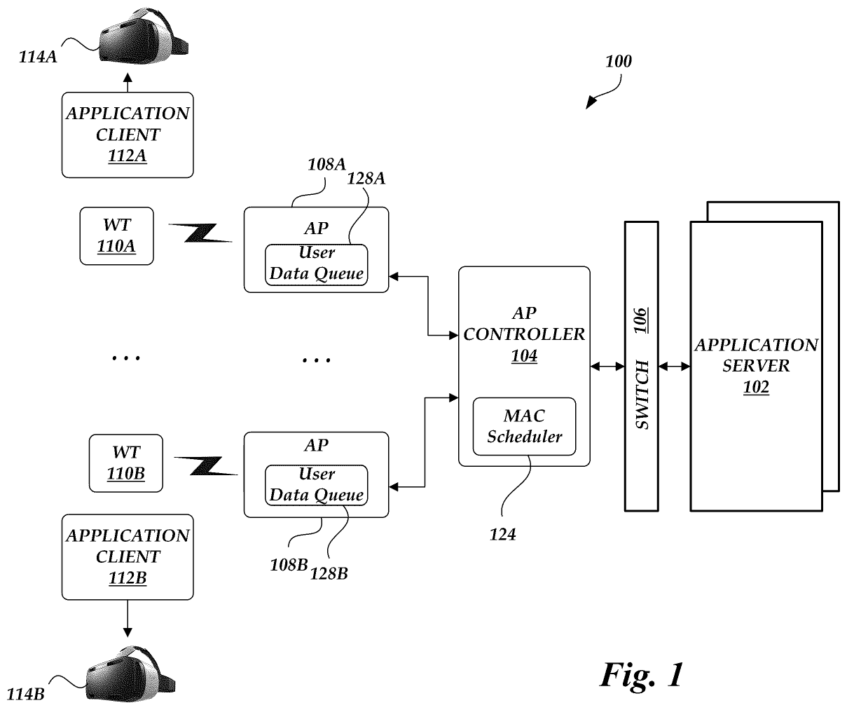

FIG. 1 is a schematic diagram of an example wireless communication environment 100 in accordance with embodiments of this disclosure. One or more application servers 102 are in communication with an access point (AP) controller 104. There can be a switch 106 coupled between application servers 102 and the AP controller 104. The switch 106 can selectively connect one or more application servers 102 to the AP controller 104. The AP controller 104 can be connected to a plurality of wireless APs 108A, 108B. The AP controller 104 can include a first interface to communicate with an AP 108A. The AP controller 104 and the APs 108A, 108B can be connected via a physical connection, such as a wired and/or optical fiber connection. In some other applications, the AP controller 104 can wirelessly communicate with APs 108A, 108B. The APs 108A, 108B can wirelessly communicate with a plurality of wireless terminals (WTs) 110A, 110B, such as stations (STAs). The APs 108A, 108B can be referred to as wireless APs (WAPs). The WTs 110A, 110B can each run a respective application client 112A, 112B. One or more wireless terminals WTs 110A, 110B, such as STAs, can be associated with a respective head-mounted display (HMD) 114A, 114B in certain applications. For example, the WT 110A can include a HMD 114A or be connected to a HMD 114A. The WTs 110A, 100B are user devices in the wireless communication environment 100.

The AP controller 104 includes a MAC scheduler 124. The MAC scheduler 124 can be implemented by any suitable hardware of the AP controller 104. For example, the AP controller 104 can include a processor and memory, where the processor can execute instructions stored in the memory to perform any suitable functions of the MAC scheduler 124 disclosed herein. The MAC scheduler 124 can perform rate selection for wireless communications between respective APs 108A, 108B and WTs 110A, 110B. The application server 102 can send a set of supported transmission rates to the AP controller 104 for rate selection. More details about rate selection that can be performed by the MAC scheduler 124 are discussed below. The AP controller 104 can include a second interface configured to communicate with an application server 102. The AP controller 104 can send a selected rate to the application server 102 via the second interface. As illustrated in FIG. 1, communications between the AP controller 104 and the application server 102 can be routed via the switch 106. The one or more application servers 102 can send data to the AP controller 104 at the selected rate. The AP controller 104 sends the data to APs 108A, 108B that wirelessly communicate with wireless terminals 110A, 110B.

Each AP 108A, 108B can include a respective user data queue block 128A, 128B. The user data queue blocks 128A, 128B can each store data packets for transmitting to a WT 110A, 110B. The user data queue blocks 128A, 128B can beach be implemented by any suitable circuitry. The user data queue blocks 128A, 128B can include a per application user data queue for each WT 110A, 110B. The user data queue blocks 128A, 128B can each measure a first number of packets that arrive at a user data queue and a second number of packets from the user data queue that are wirelessly transmitted by a respective AP 108A, 108B. The user data queue blocks 128A, 128B can each compute a queue stability metric. The APs 108A, 108B can each include a data queue for each user device it is serving.

Wireless radio frequency signals can be communicated via wireless links between the APs 108A, 108B and WTs 110A, 110B. In certain applications, the radio frequency signals have frequencies above 20 gigahertz (GHz) and/or in the millimeter wave (mmW) range. The APs 108A, 108B and wireless terminals 110A, 110B can wirelessly communicate radio frequency signals having frequencies in a range from 50 GHz to 80 GHz in some applications. The radio frequency signals can have frequencies in an unlicensed spectrum in various applications. In some applications, APs 108A, 108B and wireless terminals 110A, 110B wirelessly communicate using an 802.11 standard, such as an 802.11ad standard. According to some other applications, the wireless transmissions can be cellular communications, such as New Radio (NR) communications within Frequency Range 2 (FR2).

Wireless terminals 110A, 110B can send uplink reference signals. For example, the uplink sounding signals, such as an uplink Sounding Reference Signal (SRS), can be wirelessly transmitted from the wireless terminals 110A, 110B to the APs 108A, 108B. The uplink reference signals can be referred to as uplink sounding signals in certain applications. The AP controller 104 can receive uplink reference signals via APs 108A, 108B. The AP controller 104 can have full visibility between any wireless terminal 110A, 110B and any AP 108A, 108B. The AP controller 104 can use the uplink reference signals to perform downlink link selection and rate control for the APs 108A, 108B to wirelessly transmit data to the wireless terminals 110A, 110B. For example, the uplink reference signals can be used in determining a predicted transmission rate (PTR) for a WT 110A, 110B that can then be used in rate selection in certain instances.

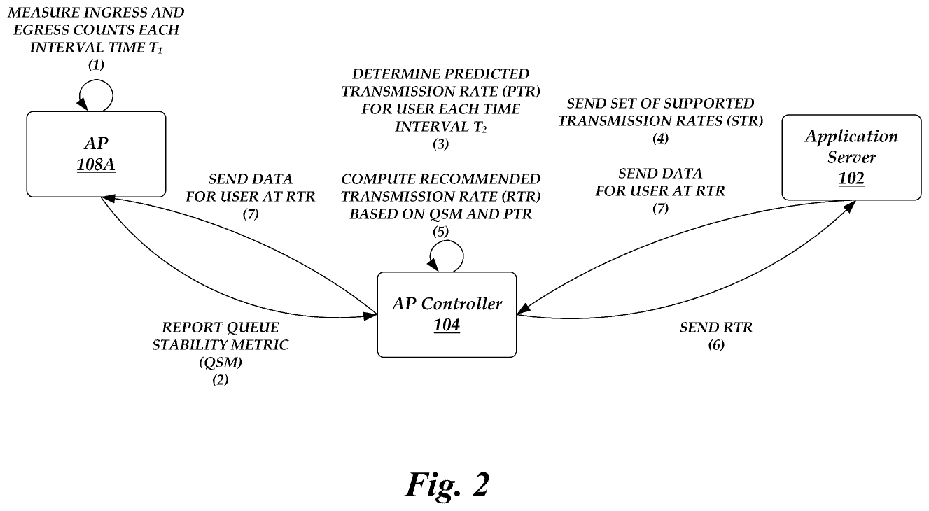

FIG. 2 is a block diagram of components of the wireless communication environment 100 of FIG. 1 illustrating operations performed by the components for cross layer rate control according to an embodiment. In FIG. 2, the application server 102, the AP controller 104, and an AP 108A are illustrated. With reference to FIG. 2, interactions between the application server 102, the AP controller 104, and the AP 108A will be described.

In the wireless communication environment 100 of FIG. 1, there can be three entities involved in rate selection: a user application, an AP controller, and a serving AP. FIG. 2 illustrates components corresponding to these entities. A user application can run on the application server 102 on the server side. The application server 102 can be logical entity that is implemented on one or more physical servers. In some instances, one physical server can implement two or more application servers 102. The client side of the user application can run on a user device, such as a HMD 114A of FIG. 1, a laptop, or another suitable user device. The AP controller 104 includes a MAC scheduler 124. The AP controller 104 can control multiple APs 108A, 108B, route user data from the application server 102 to a user device via a serving AP 108A. The serving AP 108A is the AP of the group of APs 108A, 108B that serves the user device running the user application on the client side. The serving AP 108A receives user application data from the application server 102 via the AP controller 104.

The serving AP 108A can include a data queue for a user device. The data queue can store packets for transmission to the user device. The data queue can be a per application data queue. When more packets are entering the AP for an application than being wirelessly transmitted from the AP for the application, technical problems can be encountered, such as packets getting dropped or dumped. The serving AP 108A can take measurements and determine a metric to provide to the AP controller 104 to indicate congestion.

The serving AP 108A can measure an ingress count and an egress count at each time interval T₁ at operation (1). The time interval T₁ can be any suitable time interval. As one example, T₁ can be 100 milliseconds (ms). The ingress count is the number of packets that arrived in the data queue that are destined for the user device. The egress count is the number of packets from the data queue that were wirelessly transmitted over the air from the serving AP 108A to the user device.

After the measurement at operation (1), the serving AP 108A can compute a queue stability metric (QSM). The QSM represents the stability of a queue in terms of packets entering the data queue and packets from the data queue being transmitted from the serving AP 108A. As one example, the QSM can represent the ingress count minus the egress count. As another example, the QSM can represent the ingress count divided by the egress count. A higher value of the QSM can indicate congestion where packets are arriving at a faster rate than packets are wirelessly transmitted to the user device. Generally, a QSM that is a low value is desirable. When the QSM represents the ingress count minus egress count, a QSM of zero can be the most desirable value. When the QSM represents the ingress divided by egress count, a QSM of one can be the most desirable value.

At operation (2), the serving AP 108A can report the QSM to the AP controller 104. In some other applications, the serving AP 108A can send values (e.g., the ingress count and the egress count) from which the AP controller 104 can compute the QSM.

The AP controller 104 can compute a predicted transmission rate (PTR) for the user device at each time interval T₂ at operation (3). The PTR can be in megabits per second (Mbps). The PTR can be computed based on information associated with a wireless channel between the serving AP 108A and the user device. In certain applications, the PTR can be computed based on one or more of the following: an estimate of the signal to interference and noise of the wireless channel between the serving AP 108A and the user device, an amount of air-time allocated to the user device by the scheduler, an estimate of the signal strength of the wireless channel between the serving AP 108A and the user device. In some applications, the AP controller 104 can compute the PTR based on information associated with an uplink reference signal (e.g., an uplink SRS). The AP 108A can compute the PTR instead of the AP controller 104 in certain applications, and then the AP 108A can provide the PTR to the AP controller 104 in such applications.

At operation (4), the application server 102 sends the AP controller 104 a set of supported transmission rates (STR) for the user device for the user application. The set of STR can include any suitable number of transmission rates that is greater than one, such as but not limited to 3 or 10. In certain applications, the set of STR is static and does not change for an application for the user device.

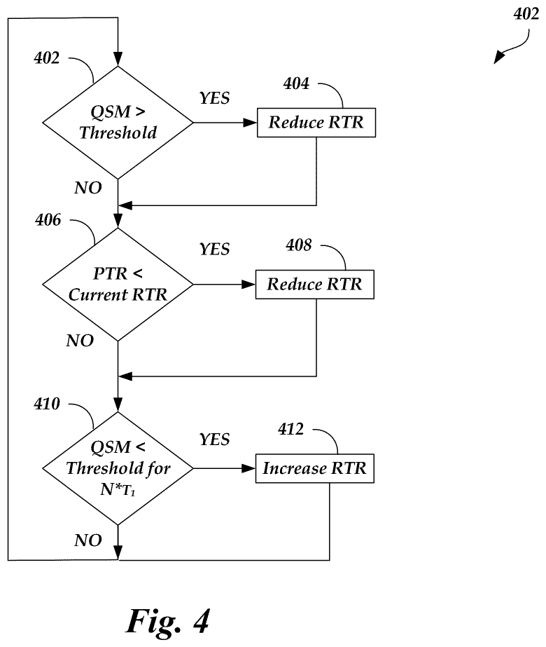

For each user device, the MAC scheduler can use the QSM and PTR to compute a recommended transmission rate (RTR). For example, at operation (5), the MAC scheduler of the AP controller 104 computes the RTR for the user device based on the QSM and the PTR for the user device. Then the AP controller 104 sends the RTR to the application server 102 at operation (6). The application server 102 can implicitly or explicitly accept the RTR as the rate for transmitting data for the user device. The RTR selected at operation (5) can be one of the rates of the set of STR sent by the application server 102. More details regarding an example of determining RTR will be discussed with reference to FIG. 4. RTR can be determined by other suitable methods than the method of FIG. 4 in certain instances.

In response to receipt of an RTR from the MAC scheduler, the application server 102 transmits data for the user device at the RTR at operation (7). The data for the user is transmitted from the application server 102 to the user device via the AP controller 104 and the serving AP 108A. The AP controller 104 can provide the user data from the application server 102 to the serving AP 108A at the RTR.

The operations discussed with reference to FIG. 2 can be performed in any suitable order. Prior to computing the RTR at operation (5), the AP controller 104 should have the QSM, PTR, and set of STR. In certain applications, the QSM and PTR can each be periodically computed at different intervals. Such computations can be performed in parallel. The QSM and PTR can be determined in any suitable order. In some instances, the set of STR can be sent for operation (4) a single time for an application for the user device. The set of STR can be sent before or after computing the QSM and/or PTR. The operations that depend on the RTR are performed after the RTR being utilized for those operations is computed at operation (5).

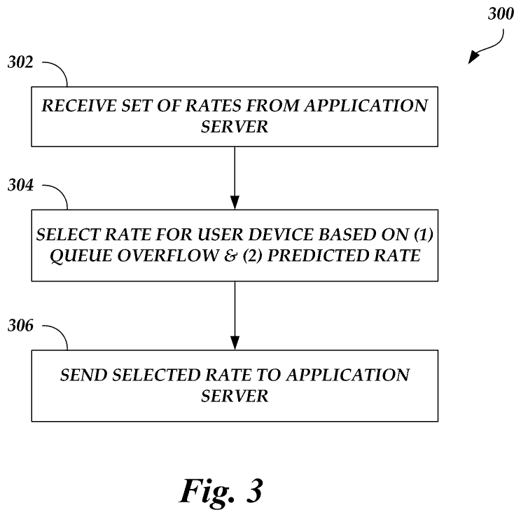

FIG. 3 is a flow diagram of operations performed by an access point controller for a cross layer rate control method 300 according to an embodiment. The method 300 can be executed by an AP controller 104 of FIG. 1 and/or FIG. 2. The MAC scheduler 124 of the AP controller 104 can perform some or all of the method 300.

At block 302, the AP controller 104 receives a set of rates from the application server 102. The set of rates are associated with an application and a user device. The AP controller 104 selects a rate for transmitting data for the user device based on an indication of queue overflow, such as QSM, and a predicted rate, such as PRT, at block 304. The AP controller 104 selects the rate from the set of rates received at block 302. A MAC scheduler 124 can perform the rate selection. The selected rate is sent to the application server 102 at operation 306. The application server 102 uses the selected rate to provide packets to the AP controller 104 for the user device at the selected rate. The AP controller 104 can provide the packets to a serving AP at the rate.

FIG. 4 is a flow diagram of operations performed in a method 400 of computing a RTR according to an embodiment. The method 400 can be executed by an AP controller 104 of FIG. 1 and/or FIG. 2. The MAC scheduler 124 of the AP controller 104 can perform the method 400. The method 400 includes three triggers that can adjust the RTR.

At block 402, the QSM is compared to a threshold. As discussed above, higher QSM can indicate congestion. If the QSM is greater than the threshold, then the RTR is reduced at block 404. This can be a first trigger for adjusting RTR. The RTR can be reduced to the next lowest rate from the set of STR at block 404. In the case that the RTR is the lowest rate in the set of STR and the QSM is greater than the threshold, data transmission from the application server 102 can stop or pause or continue without any reduction in rate. If the QSM is not greater than the threshold at block 402, the RTR can remain the same.

At block 406, the PTR is compared to the current RTR. If the PTR is less than the current RTR, then the RTR is reduced at block 408. This can be a second trigger for adjusting RTR. The RTR can be reduced to the largest rate of the set of STR that is smaller than the PTR at block 408. In the case that the RTR is the lowest rate in the set of STR and the PTR is lower than this RTR, data transmission from the application server 102 can stop or pause or continue without any reduction in rate. If the PTR is not less than the threshold at block 406, the RTR can remain the same.

At block 410, the QSM is compared to a threshold for a period of time. This can be a third trigger for adjusting RTR. The period of time can be a positive integer multiple N of the time interval T₁ for computing the QSM. The threshold for the comparison at block 410 can be the same as the threshold for the comparison at block 402 in certain applications. The threshold for the comparison at block 406 can be different than the threshold for the comparison at block 402 in some other applications.

If the QSM is below the threshold for the period of time for the comparison at block 410, the RTR can be increased at block 412. The RTR can be increased to the next highest rate of the set of STR. If the RTR is already at the highest rate of the set of STR, the RTR can be unchanged. The QSM being below the threshold for the period of time can indicate that the queue for the user device for the application has been stable for the period of time (e.g., N consecutive intervals of the time interval T₁) at the current RTR, and RTR can be increased. If the QSM is above the threshold for the period of time for the comparison at block 410, the RTR can remain the same. The method 400 can then proceed to the comparison at block 402.

The parameter N for the period of time in the comparison at block 410 can be static or adaptive. A larger value of N can slow down the speed at which the RTR adjustment algorithm reacts to an improvement in the quality of the wireless channel between the serving AP and the user device relative to a smaller value of N.

For dynamically adjusting parameter N for the period of time in the comparison at block 410, there can be rules for adjusting N. N can have a value in a range from Nmin to Nmax. N can be increased in association with RTR being reduced. As one example, N can be increased by a factor of 2 in association with RTR being reduced. N can be decreased in association with Nmax consecutive reports with QSM being less than a threshold. This can involve decreasing N to Nmin, decreasing N by a factor of 4, or any other suitable reduction of N.

The comparisons and RTR adjustments in the method 400 can be performed in any suitable order. The comparisons and RTR adjustments can be performed in serial in any suitable order, in parallel, or any suitable combination thereof. In certain applications, the comparisons at blocks 402, 406, and 412 can be performed in parallel at different intervals of time. The comparisons at blocks 402, 406, and 412 can be performed periodically while an application server is providing data for a user device to an AP controller.

In certain cases, RTR adjustments based on a comparison in the method 400 can be invalidated. An RTR adjustment that is invalidated is not acted upon and RTR can remain the same. When the first trigger and the second trigger both indicate to reduce RTR within a short period of time, one of these triggers can be ignored. For instance, the later of these triggers to fire can be invalidated or ignored. As an example, if the comparison at block 402 indicates to reduce RTR at block 404 and then the comparison at block 406 indicates to reduce RTR at block 408 within a short period of time, then the RTR reduction from the comparison at block 406 can be invalidated. The short period of time can be any suitable period of time, such as 10 ms or the time interval T₁/5. The short period of time can be a predetermined period of time.

When the third trigger is received soon after either the first trigger or the second trigger, the third trigger can be ignored. For example, the third trigger can be invalidated when the comparison at block 410 indicates to increase RTR within a short interval after the comparison at block 406 indicates to reduce RTR. The short interval can be any suitable period of time, such as 10 ms or the time interval time interval T₁/5. When either the first trigger or the second trigger is received soon after the third trigger, then the first trigger or the second trigger can be invalidated or ignored.

Operations in methods discussed with reference to FIGS. 2 to 4 can be performed for a user device being served by an AP for an application. Such operations can be performed for each user device in a wireless environment.

In some instances, two or more APs can concurrently serve a user device for a single application. In such instances, rate selection in accordance with any suitable principles and advantages disclosed herein can be performed per serving AP for the data for the user device.

In some instances, an AP can concurrently serve two or more user devices. In such instances, the AP can include different data queues for each user device and rate selection in accordance with any suitable principles and advantages disclosed herein can be performed per user device for the AP. The AP can then receive data for serving the user devices at respective selected rates. The selected rates can be the same or different depending on rate selection.

For handover when a user device transitions from being served by an outgoing AP to being served by an incoming AP, metrics can be recalculated and rate selection can be performed for the incoming AP.

In certain applications, any suitable operations of FIGS. 2 to 4 are performed for a user device that is running a single application. In some instances, the user device can run two or more applications. In such instances, RTR can be computed (1) for each application of the user device based on one or more per application metrics (e.g., QSM and/or PTR) and/or (2) for an application based on one or more metrics (e.g., QSM and/or PTR) associated with two or more applications running on the user device.

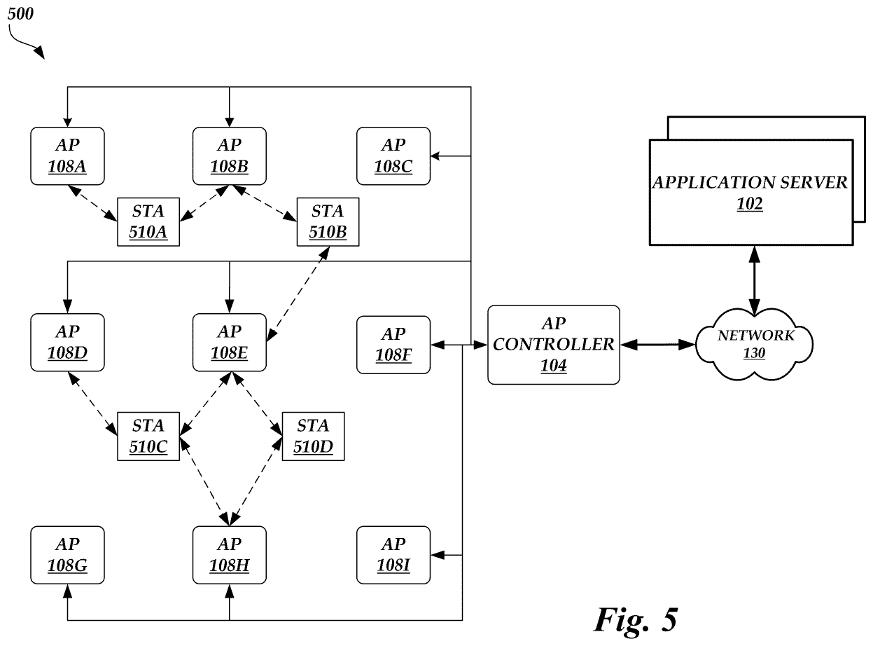

FIG. 5 is a diagram of an example multipoint environment 500 in which multiple stations (STAs) 510A to 510D and APs 108A to 108I can wirelessly communicate with each other in accordance with any suitable principles and advantages disclosed herein. STAs 510A to 510D are examples of WTs 110A, 110B of FIG. 1. The illustrated APs 108A to 108I, AP controller 104, and application server 102 are examples of devices that can perform features of cross layer rate selection disclosed herein. APs 108A to 108I can serve STAs 510A to 510D at a rate selected in accordance with any suitable principles and advantages disclosed herein. The STAs 510A to 510D are example wireless terminals or user devices. The APs 108A to 108I are example network nodes. The APs 108A to 108I can be referred to as serving nodes.

As illustrated in FIG. 5, the multipoint environment 500 includes a plurality of APs 108A to 108I, a plurality of STAs 510A to 510D, an AP controller 104, and one or more application servers 102 that can communicate with the AP controller 104 via a network 130. In an embodiment, an application server 102 can provide data packets for a particular STA of the STAs 510A to 510D to the AP controller 104 via the network 130. The AP controller 104 can provide data packets from the application server 102 to a serving AP of the APs 108A to 108I. The serving AP can wirelessly transmit the data packets form the application server 102 to the particular STA. In some instances, the AP controller 104 can provide data packets from the application server 102 to one or more serving APs for a particular STA.

A STA 510A to 510D can wirelessly communicate with multiple APs 108A to 108I and an AP 108A to 108I can communicate with multiple STAs 510A to 510D in a single wireless stack (e.g., a single IEEE 802.11 protocol stack). For example, a STA 510A to 510D can authenticate concurrently with multiple APs 108A to 108I and decode any data packet that includes a destination address that matches an address of the STA 510A to 510D in a header and/or preamble, irrespective of the source address included in the header or preamble of the data packet. Similarly, an AP 108A to 108I can decode any data packet that includes a destination address that matches an address of the AP 108A to 108I or that matches a wildcard address associated with the AP 108A to 108I in a header or preamble, irrespective of the source address included in the header of the data packet. For example, a wildcard address may be an address associated with multiple APs 108A to 108I rather than a unique address associated with just one AP 108A to 108I.

For the purposes of illustration and not meant to be limiting, as illustrated in FIG. 5, STA 510A communicates with APs 108A and 108B, STA 510B communicates with APs 108B and 108E, STA 510C communicates with APs 108D, 108E, and 108H, and STA 510D communicates with APs 108E and 108H. The STAs 510A to 510D and APs 108A to 108I, however, can communicate with other APs 108A to 108I and/or STAs 510A to 510D. Thus, unlike wireless network environments in which a basic service set (BSS) includes one AP assigned to one or more STAs, the multipoint environment 500 has no pre-defined AP 108A to 108I to which a STA 510A to 510D is associated. Rather, the AP 108A to 108I transmitting a data packet to a particular STA 510A to 510D can change on a packet-by-packet basis. For example, the AP 108D can transmit a first data packet to the STA 510C at a first time, the AP 108E can transmit a second data packet to the STA 510C at a second time, the AP 108H can transmit a third data packet to the STA 510C at a third time, the AP 108D can transmit a fourth data packet to the STA 510C at a fourth time, and so on. In fact, the AP 108A to 108I that transmits a data packet to the STA 510A to 510D can change without the STA 510A to 510D changing BSSs to which the STA 510A to 510D is associated—the STA 510A to 510D may remain in the same BSS using the same, single wireless stack while the AP 108A to 108I that transmits data packets to the STA 510A to 510D changes. Similarly, there may be no pre-defined STA 510A to 510D to which an AP 108A to 108I is associated. Rather, the STA 510A to 510D transmitting a data packet to a particular AP 108A to 108I can change on a packet-by-packet basis.

The AP controller 104 can be configured to select the AP 108A to 108I to transmit a data packet to a STA 510A to 510D. For example, the AP controller 104 can route traffic to one or more APs 108A to 108I for transmission to one or more STAs 510A to 510D based on downlink and/or uplink channel quality measurements. The AP controller 104 can be in communication with one or more application servers 102. The AP controller 104 can include a MAC scheduler in accordance with any suitable principles and advantages disclosed herein. A downlink (DL) transmission generally refers to a communication from a network system (e.g., an AP) to a user terminal (e.g., a STA). An uplink (UL) transmission generally refers to a communication from the user terminal to the network system.

The AP controller 104 can include any suitable physical hardware to perform any of the operations of the AP controllers disclosed herein. The AP controller 104 can include memory and one or more processors configured to cause the AP controller 104 to perform any suitable functionality of AP controllers disclosed herein. The AP controller 104 can store computer-executable instructions in the memory that, when executed by the one or more processors, cause the AP controller 104 to perform any suitable AP controller functionality disclosed herein. The memory is an example of non-transitory computer readable storage.

A processor of the AP controller 104 or an AP 108A to 108I can include, but is not limited to, a processor configured with specific executable instructions, a microprocessor, a microcontroller, a digital signal processor (DSP), an application specific integrated circuit (ASIC), a programmable logic device such as field programmable gate array (FPGA), the like, or any combination thereof designed to perform any suitable combination of the functions described herein. The processor can be implemented by any suitable combination of computing devices and/or discrete processing circuits in certain applications. The processor can be programmed by specific executable instructions to perform a method with any suitable combination of features disclosed herein. The processor can perform baseband processing. Such a processor can be referred to as a baseband processor.

The AP controller 104 can include one or more interfaces to communicate via a wired and/or wireless connection (e.g., Ethernet connection, optical fiber, IEEE 802.11 connection, etc.) with the network 130, the application server(s) 102, and/or the APs 108A to 108I. For example, the AP controller 104 can include a first interface for communicating with a serving AP of the APs 108A to 108I and a second interface for communicating with the application server 102 via the network 130. In certain applications, the first interface and the second interface can be wired interfaces. The AP controller 104 can include one or more interfaces for communicating with the APs 108A to 108I. For instance, the AP controller 104 can include an interface for each AP 108A to 108I. Alternatively, an interface of the AP controller 104 can be utilized to communicate with two or more of the APs 108A to 108I. As another example, in some applications, the AP controller 104 can include a single interface that allows the AP controller 104 to communicate with one or more of the APs 108A to 108I and the network 130, where a switch coupled to the interface or otherwise incorporated in the AP controller 104 can control to which component a transmission from the AP controller 104.

The APs 108A to 108I can each include one or more antennas and a processor configured to cause the AP to perform any suitable functionality of APs disclosed herein. The APs 108A to 108I can include any suitable physical hardware to perform any of the operations of the APs disclosed herein. The APs 108A to 108I can store computer-executable instructions that, when executed by one or more processors, cause the AP to perform any suitable AP functionality disclosed herein.

Each AP 108A, 108B can include a respective user data queue block. The user data queue block can include a user data queue for each application per STA that the AP is serving. The user data queue block can take measurements associated with data packet throughput. In certain applications, the user data queue block can determine QSM. The QSM can be associated with a user data queue for an application for a particular STA.

The APs 108A to 108I may each have one or more transmit antennas that each support one or more digital basebands. In some embodiments, each AP 108A to 108I has the same number of transmit antennas. In some other embodiments, some or all APs 108A to 108I have a different number of transmit antennas than other APs 108A to 108I. Thus, the APs 108A to 108I may collectively be capable of transmitting N spatial beams, where N is the product of the number of APs 108A to 108I in the multipoint environment 500 and the number of transmit antennas operated by a single AP 108A to 108I. Similarly, each AP 108A to 108I can have the same number or different number of receive antennas. In some instances, one or more of the APs 108A to 108I can include one or more antennas for transmitting and receiving. The AP controller 104 and the APs 108A to 108I can be included in a network system.

Various standards and protocols may be included in the multipoint environment 500 to wirelessly communicate data between a network node (e.g., an AP 108) and a wireless communication device (e.g., a STA 510). Some wireless devices may communicate using an IEEE 802.11 standard, which may be known as Wi-Fi. As an example, the IEEE 802.11 standard can be an 802.11ad standard. Some wireless devices may communicate using an orthogonal frequency-division multiplexing (OFDM) digital modulation scheme via a physical layer. While the multipoint environment 500 may be described with terminology that can be associated with Wi-Fi, any suitable principles and advantages associated with the multipoint environment 500 can be applied to communications with any suitable communication standards and/or protocols, such as but not limited to third generation partnership project (3GPP) New Radio (NR), 3GPP Long Term Evolution (LTE), the Institute of Electrical and Electronics Engineers (IEEE) 802.16 standard (e.g., 802.16e, 802.16m), which may be known as WiMAX (Worldwide interoperability for Microwave Access), or the like.

The wireless communication device may be referred to as a station (STA) (e.g., for wireless communication devices that communicate using the IEEE 802.11 standard). The wireless communication device may also be referred to as a UE (e.g., for wireless communication devices that communicate in a radio access network (RAN)). The wireless communication device may be a device used by a user such as cellular telephone, a smartphone, a laptop, an extended reality terminal, a wireless device integrated with a head mounted display, a tablet computer, a wearable computing device such as smart glasses or a smart watch or an ear piece, one or more networked appliances (e.g., consumer networked appliances or industrial plant equipment), an industrial robot with connectivity, or a vehicle. In some implementations, the STA may include a sensor or other networked device configured to collect data and wirelessly provide the data to a device (e.g., server) connected to a core network such as the Internet. Such devices may be referred to as Internet of Things devices (IoT devices). In some instances, a wireless communication device can be a network node.

The network 130 may include any suitable wired network, wireless network, or a combination thereof. For example, the network 130 may be a personal area network, local area network, wide area network, over-the-air broadcast network (e.g., for radio or television), cable network, satellite network, cellular telephone network, or combination thereof. As a further example, the network 130 may be a publicly accessible network of linked networks, possibly operated by various distinct parties, such as the Internet. In some embodiments, the network 130 may be a private or semi-private network, such as a corporate or university intranet. The network 130 may include one or more wireless networks, such as a Global System for Mobile Communications (GSM) network, a Code Division Multiple Access (CDMA) network, a Long Term Evolution (LTE) network, or any other type of wireless network. The network 130 can use protocols and components for communicating via the Internet or any of the other aforementioned types of networks. For example, the protocols used by the network 130 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The AP controller 104 can function as a router to route traffic between the application server(s) 102 and the APs 108A to 108I. The AP controller 104 can implement a relatively small amount of buffering. This can contribute to the AP controller 104 routing data between the application server(s) 102 and the APs 108A to 108I with low latency. The AP controller 104 can include any suitable hardware to implement the functionality described herein. For example, the AP controller 104 can include a memory and one or more processors configured to execute instructions stored in the memory to implement one or more features disclosed herein. The AP controller 104 can include a first interface for communicating with a serving AP of the APs 108A to 108I and a second interface for communicating with an application server 102. The AP controller 104 can include a MAC scheduler. The MAC scheduler can be implemented by any suitable hardware. For example, memory and one or more processors configured to execute instructions stored in the memory can implement features of the MAC scheduler disclosed herein.

The APs 108A to 108I can be arranged as an array. All of the APs 108A to 108I can be connected to the AP controller 104. The APs 108A to 108I can be connected to the AP controller 104 via wired or wireless connections. Each AP 108A to 108I can buffer a relatively low amount of frames of data at a time. For example, an AP 108A can buffer 1 or 2 frames of data at a time in certain applications. The frames can be relatively big frames. For example, one frame can include 100 to 150 Internet protocol (IP) packets. The APs 108A to 108I are arranged to wirelessly communicate with STAs 510A to 510D. The APs 108A to 108I can communicate via any suitable wireless links, such as wireless local area network (WLAN) links. WLAN signals can have a shorter signal range than cellular signals. In some instances, the WLAN signals can have a range of about 300 feet or less. WLAN signals can have a range of about 150 feet or less in certain applications. An example of a WLAN link is a Wi-Fi link. The WLAN link can be implemented based on an IEEE 802.11 standard, such as an IEEE 802.11ad standard. The APs 108A to 108I are networking hardware devices that include any suitable physical hardware to implement the functionalities disclosed herein. Although APs are described with reference to certain embodiments for illustrative purposes, any suitable principles and advantages described with references to access points can be implemented with any other suitable serving nodes of a network system. In some instances, there can be one or more wireless hops between network nodes. Any suitable wireless link that meets latency and throughput specifications can be used. Wi-Fi links, millimeter wave (mmW) wireless area network (WAN) links, and fifth generation (5G) New Radio (NR) links in Frequency Range 2 (FR2) are non-limiting examples of such suitable wireless links.

Although embodiments disclosed herein may be discussed with reference to user devices/WTs/STAs, APs, and AP controllers for illustrative purposes, any suitable principles and advantages disclosed herein can be applied to wireless communication between wireless communication devices and network nodes. For example, in certain cellular applications, a wireless communication device can be a user equipment and a network node can be a remote radio unit (RRU) of a cellular network. Moreover, any suitable principles and advantages disclosed herein can be applied to wireless communication between a plurality of wireless communication nodes. Such wireless communication nodes can include a plurality of network nodes. Alternatively or additionally, such wireless communication nodes can include a plurality of user wireless communication terminals.

Depending on the embodiment, certain acts, events, or functions of any of the processes or algorithms described herein can be performed in a different sequence, can be added, merged, or left out altogether (e.g., not all described operations or events are necessary for the practice of the process or algorithm). Moreover, in certain embodiments, operations, or events can be performed concurrently, e.g., through multi-threaded processing, interrupt processing, or multiple processors or processor cores or on other parallel architectures, rather than sequentially. Any suitable combination of parallel and/or sequential execution of a method disclosed herein can be performed.

Conditional language used herein, such as, among others, “can,” “could,” “might,” “may,” “e.g.,” “such as,” and the like, unless specifically stated otherwise, or otherwise understood within the context as used, is generally intended to convey that certain embodiments include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without other input or prompting, whether these features, elements, and/or steps are included or are to be performed in any particular embodiment. The terms “comprising,” “including,” and the like are synonymous and are used inclusively, in an open-ended fashion, and do not exclude additional elements, features, acts, operations, and so forth. Additionally, the words “herein,” “above,” “below,” and words of similar import, when used in this application, shall refer to this application as a whole and not to any particular portions of this application. Where the context permits, words in the above Detailed Description of Certain Embodiments using the singular or plural may also include the plural or singular, respectively. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated or generally understood from context, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements. Connections can be via an air interface and/or via wires and/or via optical fiber and/or via any other suitable connection.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. Also, “determining” may include resolving, selecting, choosing, establishing, and the like via a hardware element without user intervention.

While the above detailed description has shown, described, and pointed out novel features as applied to various embodiments, it can be understood that various omissions, substitutions, and changes in the form and details of the devices or algorithms illustrated can be made without departing from the spirit of the disclosure. For example, circuit blocks and/or method blocks described herein may be deleted, moved, added, subdivided, combined, arranged in a different order, and/or modified. Each of these blocks may be implemented in a variety of different ways. Any portion of any of the methods disclosed herein can be performed in association with specific instructions stored on a non-transitory computer readable storage medium being executed by one or more processors. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope

What is claimed is:

1. A method of cross layer rate selection, the method comprising:
selecting, by a media access control (MAC) scheduler, a rate for transmitting data for a wireless terminal based on (1) a queue stability metric and (2) a predicted transmission rate associated with the wireless terminal; and
sending information identifying the rate to an application server.

2. The method of claim 1, wherein an access point controller includes the MAC scheduler.

3. The method of claim 2, further comprising:
measuring, by an access point serving the wireless terminal, a first number of packets arriving in a wireless terminal data queue and a second number of packets from the wireless terminal data queue that are wirelessly transmitted from the access point to the wireless terminal; and
determining the queue stability metric based on the first number of packets and the second number of packets.

4. The method of claim 2, further comprising determining, by the access point controller, the predicted transmission rate from the wireless terminal based on information associated with a wireless channel between an access point and the wireless terminal.

5. The method of claim 2, further comprising receiving data for the wireless terminal from the application server at the rate at the access point controller.

6. The method of claim 5, further comprising wirelessly transmitting the data to the wireless terminal from an access point that is in communication with the access point controller, wherein the wireless terminal is associated with a head-mounted display.

7. The method of claim 2, further comprising:
determining, an access point serving the wireless terminal, the queue stability metric at a first time interval; and
computing, by the access point controller, the predicted transmission rate at a second time interval, wherein the first time interval is different than the second time interval.

8. The method of claim 2, further comprising:
receiving, within a predetermined period of time, (a) a first indication to reduce the rate that is associated with the queue stability metric and (b) and a second indication to reduce the rate that is associated with the predicted transmission rate; and
invalidating, by the access point controller, one of the first indication or the second indication.

9. The method of claim 2, further comprising:
receiving, within a predetermined period of time, (a) a first indication to reduce the rate and (b) and a second indication to increase the rate; and
invalidating, by the access point controller, one of the first indication or the second indication.

10. The method of claim 1, further comprising receiving, by the MAC scheduler, a set of supported transmission rates from the application server, wherein the rate is included in the set of supported transmission rates.

11. The method of claim 1, further comprising reducing the rate based on the queue stability metric being greater than a threshold, wherein a higher value of the queue stability metric indicates more congestion than a lower value of the queue stability metric.

12. The method of claim 1, further comprising reducing the rate based on the predicted transmission rate being less than the rate.

13. The method of claim 1, further comprising increasing the rate based on the queue stability metric being less than a threshold for a predefined period of time, wherein a higher value of the queue stability metric indicates more congestion than a lower value of the queue stability metric.

14. The method of claim 1, further comprising:
selecting, by the MAC scheduler, a second rate for transmitting data for a second wireless terminal based on (1) a queue stability metric associated with the second wireless terminal and (2) a predicted transmission rate associated with the second wireless terminal; and
sending information identifying the second rate to a second application server.

15. A controller with cross layer rate selection, the controller comprising:
a one or more interfaces configured to communicate with a network node and to communicate with an application server; and
a media access control (MAC) scheduler configured to:
select a rate for transmitting data for a wireless terminal based on (1) a queue stability metric and (2) a predicted transmission rate associated with the wireless terminal;
cause the controller to send information identifying the rate to the application server; and
cause the controller to send data from the application server that is associated with the wireless terminal to the network node at the rate.

16. The controller of claim 15, wherein the one or more interfaces comprise:
a first interface configured to send the data from the application server to the network node; and
a second interface configured to send the information identifying the rate to the application server.

17. The controller of claim 15, wherein the network node is an access point, and the controller is an access point controller.

18. A system with cross layer rate selection, the system comprising:
an access point comprising at least one antenna and one or more processors in communication with the at least one antenna, wherein the one or more processors are configured to cause the access point to wirelessly transmit packets to a wireless terminal via the at least one antenna; and
an access point controller comprising a media access control (MAC) scheduler, the MAC scheduler configured to:
select a rate for transmitting data for the wireless terminal based on (1) a queue stability metric associated with the wireless terminal and (2) a predicted transmission rate associated with the wireless terminal;
cause the access point controller to send information identifying the rate to an application server; and
cause the access point controller to send data from the application server to the access point for transmission to the wireless terminal at the rate.

19. The system of claim 18, wherein the access point is configured to:
measure a first number of packets arriving in a wireless terminal data queue and a second number of packets from the wireless terminal data queue that are wirelessly transmitted from the access point to the wireless terminal;
determine the queue stability metric based on the first number of packets and the second number of packets; and
report the queue stability metric to the access point controller.

20. The system of claim 18, wherein the access point controller is configured to determine the predicted transmission rate associated with the wireless terminal based on information associated with a wireless channel between the access point and the wireless terminal.
